(19) United States
(12) Patent Application Publication
(10) Pub. No.: US 2021/0173410 A1
(43) Pub. Date: Jun. 10, 2021

(54) SYSTEM AND METHOD FOR CONTROLLING THE DIRECTION OF TRAVEL OF A WORK VEHICLE BASED ON AN ADJUSTED FIELD MAP

(71) Applicant: CNH Industrial America LLC, New Holland, PA (US)

(72) Inventors: Andrew Berridge, Burr Ridge, IL (US); Phillip Dix, Westmont, IL (US); Daniel Geiyer, Bolingbrook, IL (US); Aditya Singh, Bolingbrook, IL (US); Navneet Gulati, Naperville, IL (US)

(73) Assignee: CNH Industrial America LLC

(21) Appl. No.: 16/704,514

(22) Filed: Dec. 5, 2019

(51) Int. Cl. G05D 1/02; G01C 21/00; A01B 79/00; A01B 69/04; A01D 41/127

(52) U.S. Cl. CPC G05D 1/0274; G01C 21/005; G05D 2201/0201; A01B 69/008; A01D 41/127; A01B 79/005

(57) ABSTRACT

A system for controlling a direction of travel of a work vehicle may include a location sensor configured to capture data indicative of a location of the work vehicle within a field. A controller of the disclosed system may be configured to receive an input indicative of the vehicle being positioned at a starting point associated with a guide crop row present within the field. After receiving the input, the controller may be configured to determine the location of the guide crop row within the field based on the data captured by the location sensor. Furthermore, the controller may be configured to compare the determined location of the guide crop row and a location of a selected crop row depicted in a field map to determine an initial location differential. In addition, the controller may be configured to adjust the field map based on the determined initial location differential.

### FIELD OF THE INVENTION

The present disclosure generally relates to work vehicles and, more particularly, to systems and methods for controlling the direction of travel of a work vehicle based on an adjusted field map.

### BACKGROUND OF THE INVENTION

A harvester is an agricultural machine used to harvest and process crops. For instance, a combine harvester may be used to harvest grain crops, such as wheat, oats, rye, barley, corn, soybeans, and flax or linseed. In general, the objective is to complete several processes, which traditionally were distinct, in one pass of the machine over a portion of the field. In this respect, most harvesters are equipped with a detachable harvesting implement, such as a header, which cuts and collects the crop from the field. The harvester also includes a crop processing system, which performs various processing operations (e.g., threshing, separating, etc.) on the harvested crop received from the harvesting implement. Furthermore, the harvester includes a crop tank, which receives and stores the harvested crop after processing.

Many crops, such as corn and soybeans, are planted in rows. As such, when the harvester travels across the field, it is desirable that the direction of travel of the harvester be generally aligned with the orientation of the crop rows to maximize harvesting efficiency. In this respect, some harvesters use a GNSS-based location sensor and a field map depicting the locations of the crop crops within the field that was generated during the previous planting operation to guide the harvester relative the crop rows. However, GNSS-based sensors are subject to signal drift such that the frame of reference of the data currently being captured by the GNSS-based sensor and the data used to generate the field map may be offset. Such an offset may result in harvester being misaligned with the crop rows.

Accordingly, an improved system and method for controlling the direction of travel of a work vehicle would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for controlling a direction of travel of a work vehicle. The system may include a location sensor configured to capture data indicative of a location of the work vehicle within a field. Additionally, the system may include a controller communicatively coupled to the location sensor. As such, the controller may be configured to receive an input indicative of the work vehicle being positioned at a starting point associated with a guide crop row present within the field. Moreover, after receiving the input, the controller may be configured to determine the location of the guide crop row within the field based on the data captured by the location sensor. Furthermore, the controller may be configured to compare the determined location of the guide crop row and a location of a selected crop row depicted in a field map to determine an initial location differential. In addition, the controller may be configured to adjust the field map based on the determined initial location differential.

In another aspect, the present subject matter is directed to a method for controlling a direction of travel of a work vehicle. The method may include receiving, with one or more computing devices, an input indicative of the work vehicle being positioned at a starting point associated with a guide crop row present within a field. After receiving the input, the method may include determining, with the one or more computing devices, a location of the guide crop row within the field based on received location data. Additionally, the method may include comparing, with the one or more computing devices, the determined location of the guide crop row and a location of a selected crop row depicted in a field map to determine an initial location differential. Furthermore, the method may include adjusting, with the one or more computing devices, the field map based on the determined initial location differential. Moreover, the method may include controlling, with the one or more computing devices, the direction of travel of the work vehicle as the work vehicle travels across the field based on the adjusted field map.

These and other features, aspects and advantages of the present technology will become better understood with reference to the following description and appended claims. The accompanying drawings, which are incorporated in and constitute a part of this specification, illustrate embodiments of the technology and, together with the description, explain the principles of the technology.

### BRIEF DESCRIPTION OF THE DRAWINGS

A full and enabling disclosure of the present technology, including the best mode thereof, directed to one of ordinary skill in the art, is set forth in the specification, which reference to the appended figures, in which:

FIG. 1 illustrates a partial sectional side view of one embodiment of a work vehicle in accordance with aspects of the present subject matter;

FIG. 2 illustrates a perspective view of the work vehicle shown in FIG. 1, particularly illustrating various components of the work vehicle in accordance with aspects of the present subject matter;

FIG. 3 illustrates a schematic view of one embodiment of a system for controlling a direction of travel of a work vehicle in accordance with aspects of the present subject matter;

FIG. 4 illustrates a top view of one embodiment of a crop row sensor suitable for use within the system shown in FIG. 3 in accordance with aspects of the present subject matter;

FIG. 5 illustrates an example top view of a portion of a harvesting implement of a work vehicle being positioned relative to a plurality of crop rows within a field in accordance with aspects of the present subject matter, particularly illustrating the location of a guide crop row being laterally shifted from a location of a selected crop row depicted in a field map of the field;

FIG. 6 illustrates an example top view of a portion of a harvesting implement of a work vehicle being positioned relative to a guide crop row within the field as the vehicle travels across the field within in accordance with aspects of the present subject matter, particularly illustrating the guide crop row being rotated relative to a selected crop row depicted in a field map of the field; and

FIG. 7 illustrates a flow diagram of one embodiment of a method for controlling a direction of travel of a work vehicle in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for controlling the direction of travel of a work vehicle. Specifically, the present subject matter may be used with an agricultural harvester or any other work vehicle (e.g., a sprayer, a tractor, and/or the like) that travels across a field relative to one or more crop rows present within the field. In this respect, a controller of the disclosed system may be configured to control the direction of travel of the vehicle such that the vehicle maintains a predetermined positional relationship with the a guide crop row present within the field based on data received from a location sensor (e.g., a GNSS-based sensor) and a previously generated field map of the field (e.g., a field map generated during a previous agricultural operation).

In accordance with aspects of the present subject matter, the controller may be configured to adjust the field map such that the crops rows depicted in the map are aligned with the crop rows within the field. More specifically, the location sensor may be subject to signal drift such that the locations of the crop rows present within the field are offset from the locations of the crop rows depicted in the field map. In this respect, before performing an operation (e.g., a harvesting operation) on the field, the operator may move the vehicle to a starting point of the guide crop row within the field and provide an input (e.g., to a user interface of the vehicle) indicating the vehicle is positioned at the starting point. After receiving the input, the controller may be configured to determine the location of the guide crop row based on data received from the location sensor. Furthermore, the controller may be configured to compare the determined location of the guide crop row and the location of a selected crop row depicted in a field map to determine an initial location differential. In one embodiment, the selected crop row may correspond to the crop row depicted in the field map closest to the location of the guide crop row present within the field. The initial location differential may generally correspond to the lateral distance or offset between the crop rows present within the field and the crop rows depicted in the field map. As such, the controller may be configured to adjust the field map based on the determined initial location differential. For example, the controller may be configured to laterally shift the frame of reference of the field map based on the initial location differential such that selected crop row depicted in the field map is aligned with the guide crop row present within the field. Thereafter, the controller may be configured to control the direction of travel of the vehicle as the work vehicle travels across the field based on the adjusted field map.

Additionally, as the vehicle travels across the field, the controller may be configured to further adjust the field map when the crop rows present within the field deviate from the crop rows depicted in the field map. For example, in certain instances, as the vehicle traverses a curve, location sensor signal drift may result in the curvature of the crop rows present within the field differing from the curvature of the crop rows depicted in the field map. As such, in several embodiments, the vehicle may include a crop row sensor (e.g., a mechanical sensor or a vision-based sensor) configured to capture data indicative of the location of the guide crop row relative to the vehicle. In this respect, as the vehicle travels across the field, the controller may be configured to monitor the location the guide crop row based on data received from the crop row sensor. Thereafter, the controller may be configured to compare the monitored location of the guide crop row and the location of the selected crop row depicted in a field map to determine an operational location differential. The operational location differential may, in turn, generally correspond to the angular offset between the crop rows present within the field and the crop rows depicted in the field map. As such, the controller may further adjust the adjusted field map based on the determined operational location differential. For example, the controller may be configured to rotate the frame of reference of the field map based on the operational location differential such that the selected crop row depicted in the field map is aligned with the guide crop row present within the field.

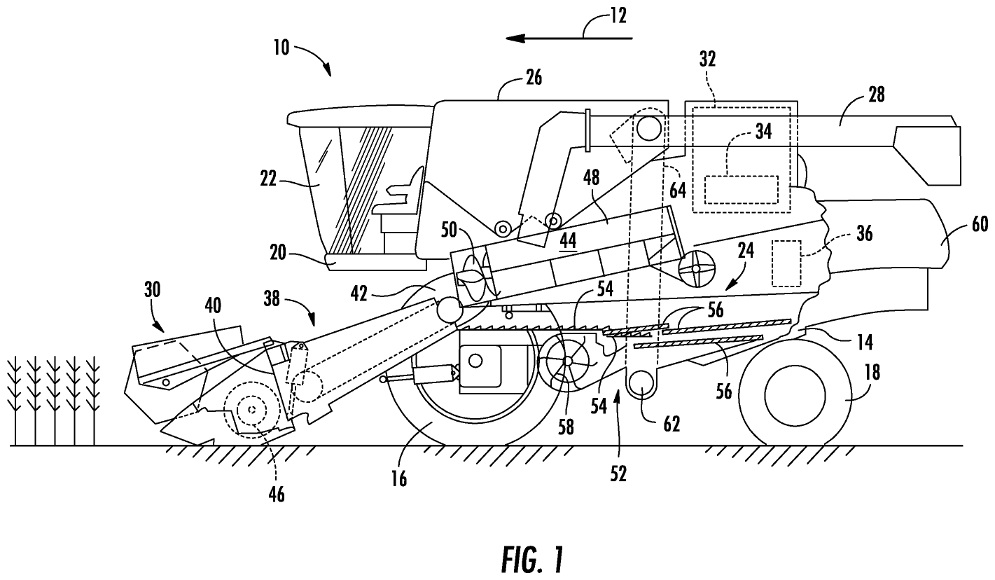

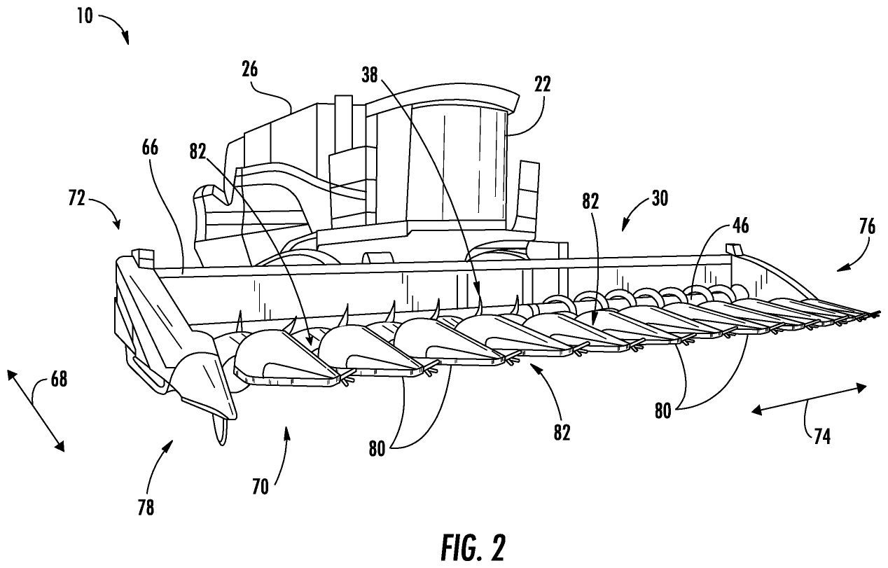

Referring now to the drawings, FIGS. 1 and 2 illustrate differing views of one embodiment of a work vehicle 10 in accordance with aspects of the present subject matter. Specifically, FIG. 1 illustrates a partial sectional side view of the vehicle 10. Additionally, FIG. 2 illustrates a perspective view of the vehicle 10, particularly illustrating various components of the vehicle 10.

In general, the vehicle 10 may be configured to travel across a field in a direction of travel (indicated by arrow 12) to relative to one or more crop rows present within the field. As shown, in several embodiments, the vehicle 10 may be configured as an agricultural harvester (e.g., an axial-flow combine). In such embodiments, while traversing the field, the vehicle 10 may be configured to harvest and subsequently process the crops present within the field. However, in alternative embodiments, the vehicle 10 may be configured as any other suitable type of work vehicle, such as an agricultural sprayer, a tractor, and/or the like.

As shown, the vehicle 10 may include a chassis or main frame 14 configured to support and/or couple to various components of the vehicle 10. For example, in several embodiments, the vehicle 10 may include a pair of driven, ground-engaging front wheels 16 and a pair of steerable rear wheels 18 coupled to the frame 14 As such, the wheels 16, 18 may be configured to support the vehicle 10 relative to the ground and move the vehicle 10 in the direction of travel 12. Furthermore, the vehicle 10 may include an operator's platform 20 having an operator's cab 22, a crop processing system 24, a crop tank 26, and the crop discharge tube 28 that are supported by the frame 14. As will be described below, the crop processing system 24 may be configured to perform various processing operations on the harvested crop as the system 24 transfers the harvested crop between a header 30 of the vehicle 10 and the crop tank 26. Moreover, the vehicle 10 may include an engine 32 and a transmission 34 mounted on the frame 14. The transmission 34 may be operably coupled to the engine 32 and may provide variably adjusted gear ratios for transferring engine power to the wheels 16 via a drive axle assembly (or via axles if multiple drive axles are employed). Additionally, the vehicle 10 may include a steering actuator 36 configured to adjust the orientation of the steerable wheels 18 relative to the frame 14. For example, the steering actuator 36 may correspond to an electric motor, a linear actuator, a hydraulic cylinder, a pneumatic cylinder, or any other suitable actuator coupled to suitable mechanical assembly, such as a rack and pinion or a worm gear assembly.

Moreover, as shown in FIG. 1, a harvesting implement, such as a header 30, and an associated feeder 38 of the crop processing system 24 may extend forward of the frame 14 and may be pivotally secured thereto for generally vertical movement. In general, the feeder 38 may support the header 30. As shown in FIG. 1, the feeder 38 may extend between a front end 40 coupled to the header 30 and a rear end 42 positioned adjacent to a threshing and separating assembly 44 of the crop processing system 24. In this respect, the rear end 42 of the feeder 38 may be pivotally coupled to a portion of the vehicle 10 to allow the front end 40 of the feeder 38 and, thus, the header 30 to be moved vertical up and down relative to the ground to set the desired harvesting or cutting height for the header 30.

As the vehicle 10 travels across the field having one or more crop rows, the crop material is severed from the stubble by a plurality of snapping rolls (not shown) and associated stripping plates (not shown) at the front of the header 30 and delivered by a header auger 46 to the front end 40 of the feeder 38, which supplies the harvested crop to the threshing and separating assembly 44. The threshing and separating assembly 44 may, in turn, include a cylindrical chamber 48 in which a rotor 50 is rotated to thresh and separate the harvested crop received therein. That is, the harvested crop is rubbed and beaten between the rotor 50 and the inner surfaces of the chamber 48 to loosen and separate the grain, seed, or the like from the straw.

The harvested crop separated by the threshing and separating assembly 44 may fall onto a crop cleaning assembly 52 of the crop processing system 24. In general, the crop cleaning assembly 52 may include a series of pans 54 and associated sieves 56. As such, the separated harvested crop may be spread out via oscillation of the pans 54 and/or sieves 56 and may eventually fall through apertures defined in the sieves 56. Additionally, a cleaning fan 58 may be positioned adjacent to one or more of the sieves 56 to provide an air flow through the sieves 56 that removes chaff and other impurities from the harvested crop. For instance, the fan 58 may blow the impurities off the harvested crop for discharge from the vehicle 10 through the outlet of a straw hood 60 positioned at the back end of the vehicle 10. The cleaned harvested crop passing through the sieves 56 may then fall into a trough of an auger 62, which may be configured to transfer the harvested crop to an elevator 64 for delivery to the crop tank 26.

Referring now to FIG. 2, the header 30 may include a header frame 66. In general, the frame 66 may extend along a longitudinal direction 68 between a forward end 70 and an aft end 72. The frame 66 may also extend along a lateral direction 74 between a first side 76 and a second side 78. In this respect, the frame 66 may be configured to support or couple to a plurality of components of the header 30. For example, a plurality of cones or row dividers 80 and the header auger 46 may be supported by the header frame 66. Additionally, the snapping rolls (not shown) and associated stripping plates (not shown) may also be supported on and coupled to the frame 66.

In several embodiments, as shown in FIG. 2, the header 30 may be configured as a corn header. In such embodiments, the plurality of row dividers 80 may extend forward from the header frame 66 along the longitudinal direction 68. Moreover, the row dividers 80 may be spaced apart along the lateral direction 74 of the header frame 66, with each adjacent pair of row dividers 88 defining an associated stalkway or recess 82 therebetween. As the vehicle 10 is moved across the field, the row dividers 80 separate the stalks of the crop such that the separated stalks are guided into the stalkways 82. Thereafter, the snapping rolls (not shown) pull the stalks downwardly onto the associated stripping plates (not shown) such that the ears of the standing crop are snapped from the associated stalks upon contact with the stripping plates. The auger 46 may then convey the harvested ears to the feeder 38 for subsequent processing by the crop processing system 24 (FIG. 1). However, in alternative embodiments, the header 30 may be configured as any other suitable type of harvesting implement, such as a draper header.

It should be further be appreciated that the configurations of the vehicle 10 and the header 30 described above and shown in FIGS. 1 and 2 are provided only to place the present subject matter in an exemplary field of use. Thus, it should be appreciated that the present subject matter may be readily adaptable to any manner of harvester and/or header configuration.

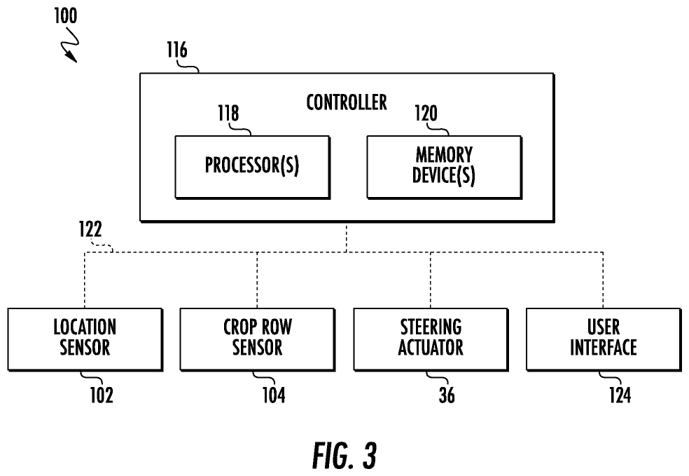

Referring now to FIG. 3, a schematic view of one embodiment of a system 100 for controlling the direction of travel of a work vehicle is illustrated in accordance with aspects of the present subject matter. In general, the system 100 will be described herein with reference to the work vehicle 10 described above with reference to FIGS. 1 and 2. However, it should be appreciated by those of ordinary skill in the art that the disclosed system 100 may generally be utilized with work vehicles having any other suitable vehicle configuration.

As shown in FIG. 3, the system 100 may include a location sensor 102 provided in operative association with the vehicle 10. In general, the location sensor 102 may be configured to capture data indicative of the current location of the vehicle 10 within the field. Specifically, in several embodiments, the location sensor 102 may be configured as a GNSS-based satellite navigation positioning system (e.g. a GPS system, a Galileo positioning system, the Global Navigation satellite system (GLONASS), the BeiDou Satellite Navigation and Positioning system, and/or the like). In such embodiments, the location data captured by the location sensor 118 may be transmitted to a controller(s) of the vehicle 10 (e.g., in the form coordinates) and stored within the controller's memory for subsequent processing and/or analysis. For instance, based on the known dimensional configuration and/or relative positioning between the location sensor 102 and the header 30 (or one or more components of the header 30) of the vehicle 10, the location data from the location sensor 102 may be used to geo-locate or otherwise determine the current location of one or more crops row present within the field.

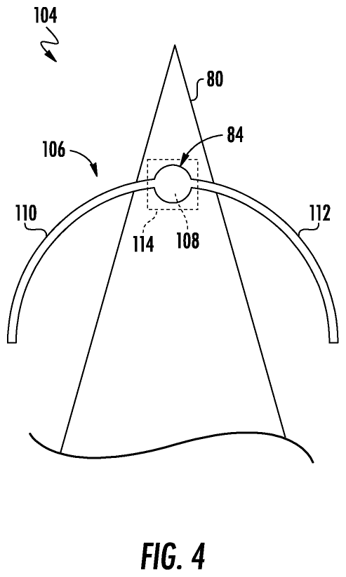

Additionally, the system 100 may include a crop row sensor 104 provided in operative association with the vehicle 10. In general, the crop row sensor 104 may be configured to capture data indicative of the location(s) of one or more crop rows present within the field relative to the vehicle 10. In several embodiments, as shown in FIG. 4, the crop row sensor 104 may be configured as a mechanical sensor mounted on a row divider 80 of the header 30 of the vehicle 10. Specifically, in such embodiments, the crop row sensor 104 may include a sensor arm 106 having a base portion 108 installed into an aperture 84 defined by the row divider 80 such that the sensor arm 106 is able to rotate relative to the row divider 80. Additionally, each crop row sensor 104 may include a potentiometer 114 configured to capture data indicative of the rotation and/or positioning of the base portion 108 relative to the row divider 80. Furthermore, the sensor arm 104 may include first and second sensor arm portions 110, 112 extending outward in the lateral direction 74 from the base portion 108 and rearwardly along the longitudinal direction 68. In this respect, as the vehicle 10 travels across the field, the adjacent crop rows present within the field may contact the first and/or second sensor arm portions 110, 112, thereby rotating the sensor arm 106 relative to the row divider 80. For example, when the vehicle 10 travels around a curve, the sensor arm portion 110, 112 positioned on the outside of the curve may contact the adjacent crop row, thereby rotating the sensor arm 106 relative to the row divider 80. The potentiometer 114 may capture data indicative of the rotation of the sensor arm 106 relative to the row divider 80. Such data may then be used to determine the location of the crop row(s) relative to the vehicle 10. However, in alternative embodiments, the crop row sensor 104 may correspond to any other suitable sensor(s) or sensing device(s) for capturing data indicative of the location(s) of one or more crop rows present within the field relative to the vehicle 10. For example, in one embodiment, the crop row sensor 102 may be configured as a vision-based sensor (e.g., a camera or LIDAR sensor). Furthermore, in some embodiments, the system 100 may include a plurality of crop row sensors 104 of the vehicle 10.

Referring again to FIG. 3, in accordance with aspects of the present subject matter, the system 100 may include a controller 116 positioned on and/or within or otherwise associated with the vehicle 10. In general, the controller 116 may comprise any suitable processor-based device known in the art, such as a computing device or any suitable combination of computing devices. Thus, in several embodiments, the controller 116 may include one or more processor(s) 118 and associated memory device(s) 120 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 120 of the controller 116 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 120 may generally be configured to store suitable computer-readable instructions that, when implemented by the processor(s) 118, configure the controller 116 to perform various computer-implemented functions.

In addition, the controller 116 may also include various other suitable components, such as a communications circuit or module, a network interface, one or more input/output channels, a data/control bus and/or the like, to allow controller 116 to be communicatively coupled to any of the various other system components described herein (e.g., the steering actuator 36, the location sensor 102, and/or the crop row sensor 104). For instance, as shown in FIG. 3, a communicative link or interface 122 (e.g., a data bus) may be provided between the controller 116 and the components 36, 102, 104 to allow the controller 116 to communicate with such components 36, 102, 104 via any suitable communications protocol (e.g., CANBUS).

It should be appreciated that the controller 116 may correspond to an existing controller(s) of the vehicle 10, itself, or the controller 116 may correspond to a separate processing device. For instance, in one embodiment, the controller 116 may form all or part of a separate plug-in module that may be installed in association with the vehicle 10 to allow for the disclosed systems to be implemented without requiring additional software to be uploaded onto existing control devices of the vehicle 10. It should also be appreciated that the functions of the controller 116 may be performed by a single processor-based device or may be distributed across any number of processor-based devices, in which instance such devices may be considered to form part of the controller 116. For instance, the functions of the controller 116 may be distributed across multiple application-specific controllers, such as a navigation controller, an engine controller, a transmission controller, and/or the like.

Furthermore, in one embodiment, the system 100 may also include a user interface 124. More specifically, the user interface 124 may be configured to receive inputs (e.g., inputs associated with the location of the vehicle 10 within the field) from the operator of the vehicle 10. As such, the user interface 124 may include one or more input devices (not shown), such as touchscreens, keypads, touchpads, knobs, buttons, sliders, switches, mice, microphones, and/or the like, configured to receive user inputs from the operator. The user interface 124 may, in turn, be communicatively coupled to the controller 116 via the communicative link 122 to permit the inputs to be transmitted from the user interface 124 to the controller 116. In addition, some embodiments of the user interface 124 may include one or more feedback devices (not shown), such as display screens, speakers, warning lights, and/or the like, which are configured to provide feedback from the controller 116 to the operator. In one embodiment, the user interface 124 may be mounted or otherwise positioned within the cab 22 of the vehicle 10. However, in alternative embodiments, the user interface 124 may mounted at any other suitable location.

In several embodiments, the controller 116 may be configured to access a field map associated with a field across which the vehicle 10 will travel. As will be described below, the accessed field map may, in combination with location data received from the location sensor 102, be used to control the direction of travel 12 of the vehicle 10 as the vehicle travels across the field to perform an operation (e.g., a harvesting operation) thereon. More specifically, during a previous operation, a field map depicting or otherwise identifying the locations of one or more crop rows present within the field may be generated. For example, in one embodiment, during a planting operation, a field map depicting the locations where seeds were deposited in the field may be generated, with such locations of the seeds corresponding to the locations of the crop rows. The generated field map may be stored within the memory device(s) 120 of the controller 116 for use during a subsequent operation. Thereafter, when it is desired to perform the subsequent operation (e.g., the harvesting operation), the controller 116 may be configured to retrieve or otherwise access the stored field map from its memory 120.

In one embodiment, the controller 116 may be configured to access the stored field map based on an input received from the operator of the vehicle 10. For example, a plurality of field maps may be stored within the memory device(s) 120 of the controller 116, with each field map corresponding to a different field on which the vehicle 10 may perform an operation. In this respect, the operator may provide an input indicative of the particular field on which the vehicle 10 is located to the user interface 124 (e.g., by interacting with the input device(s) of the user interface 124). Thereafter, the user interface 116 may be configured to transmit the operator input to the controller 116 (e.g., via the communicative link 122). Upon receipt of the operator input, the controller 116 is configured to access the corresponding field map from its memory 120. As will be described below, the controller 116 may be configured to notify the operator when the accessed field map is incorrect and does not correspond to the field on which the vehicle 10 is currently located.

As used herein, a “field map” may generally correspond to any suitable dataset that correlates data to various locations within a field. Thus, for example, a field map may simply correspond to a data table that provides the locations of the crop rows present within the field. Alternatively, a field map may correspond to a more complex data structure, such as a geospatial numerical model that can be used to identify the locations of the crop rows present within the field. In one embodiment, the controller 116 may be configured to display the field map to the operator of the vehicle 10 (e.g., via the user interface 124) as the vehicle 10 travels across the field.

Additionally, in several embodiments, the controller 116 may be configured to receive an input indicative of the vehicle 10 being positioned at a starting point associated with a guide crop row present within a field. More specifically, at the start of an operation (e.g., a harvesting operation), an operator may drive or otherwise move the vehicle 10 to a starting point of a guide crop row within present within the field. Once the vehicle 10 is positioned at the starting point, the operator may provide an input indicative of the vehicle 10 being positioned at the starting point to the user interface 124 (e.g., by interacting with the input device(s) of the user interface 124). Thereafter, the user interface 116 may be configured to transmit the operator input to the controller 116 (e.g., via the communicative link 122). Upon receipt of the operator input, the controller 116 is configured to determine that the vehicle 10 is positioned at a starting point of the guide crop row.

As used herein, a “guide crop row” may generally correspond to any crop row present within the field used to guide or otherwise control the direction of travel 12 of the vehicle 10 as the vehicle 10 travels across the field. Specifically, in several embodiments, the operator may move the vehicle 10 to the start point of any crop row present to initiate the operation. Once at the starting point, the operator may align the vehicle 10 with the crop rows such that a guide component of the vehicle 10 located at a predetermined positional relationship relative to the one of the crop rows within the field. The crop row positioned relative to the guide component may, in turn, correspond to the guide crop row. As will be described below, as vehicle 10 travels across the field, the relative positioning between the guide component and the guide crop row may be used to control the direction of travel 12 of the vehicle 10. For example, in one embodiment, the guide component may correspond to a specified row divider 80 of the header 30, such as a row divider 80 having a crop row sensor 104 positioned thereon. In such an embodiment, the operator may position the specified row divider 80 such that one of the crop rows is aligned with a stalkway 82 defined by the specified row divider 80. In this respect, the crop row aligned with the stalkway 82 defined by the specified row divider 80 may correspond to the guide crop row. As the vehicle 10 makes subsequent passes across the field, the crop row corresponding to guide crop row may change. However, in alternative embodiments, guide component may correspond to any other suitable component of the vehicle 10. For instance, in an embodiment in which the vehicle 10 is configured as a sprayer (not shown), the guide component may correspond to one of the nozzles (not shown) mounted on the sprayer.

After receiving the input indicative of the vehicle 10 being positioned at the starting point of the guide crop row, the controller 116 may be configured to determine the location of the guide crop row within the field. As described above, the system 100 may include a location sensor 102 configured to capture data indicative of location of the vehicle 10 within the field. In this respect, once the vehicle 10 is positioned at the starting point of the guide crop row, the controller 102 may be configured to receive location data (e.g., coordinates) from the location sensor 102 (e.g., via the communicative link 122). Thereafter, based on the received location data and the known dimensional and/or geometric relationship between the location sensor 102 and the guide crop row, the controller 102 may be configured to determine the location of the guide crop row within the field. For example, in embodiments in which the guide component of the vehicle 10 corresponds to a specified row divider 80, the controller 102 may be configured to determine the location of the guide crop row based on the received location data and the dimensional/geometric relationship between the location sensor 102 and the stalkway 82 with which the guide crop is aligned (e.g., the stalkway 82 defined by the specified row divider 80).

Additionally, the controller 116 may be configured to compare the determined location of the guide crop row and the location of a selected crop row depicted in a field map. As described above, the location sensor 102 may experience signal drift. Signal drift may, in turn, cause the positions of the crop rows present within the field (e.g., at the time of harvest) to differ from the positions of the crop rows depicted in the field map (e.g., generated during planting). Specifically, such signal drift may cause the frame of reference of the location data currently being captured (e.g., to determine the location of the guide crop row) to differ from the frame of reference of the location data captured during the previous operation and used to generate the field. As such, in certain instances, the determined position of the guide crop row may be offset (e.g., in the lateral direction 74) from all the crop rows depicted with the field map. In this respect, the controller 116 may be configured to compare to determined location of the guide crop row and the location of a selected crop row depicted in the field map to determine an initial location differential. As will be described below, the controller 116 may use determined initial location differential to adjust the field map such that the selected crop row is aligned with the guide crop row.

The selected crop row may correspond to any crop row depicted in the field map. For example, in one embodiment, the selected crop row may correspond to the crop row positioned closest to the determined location of the guide crop row. Such a selection may require the least amount of adjustment to the field map to align the selected crop row with the guide crop row. However, as all the crop rows in the field are generally parallel, the controller 116 may be configured to select any other crop row depicted in the field map as the selected crop row.

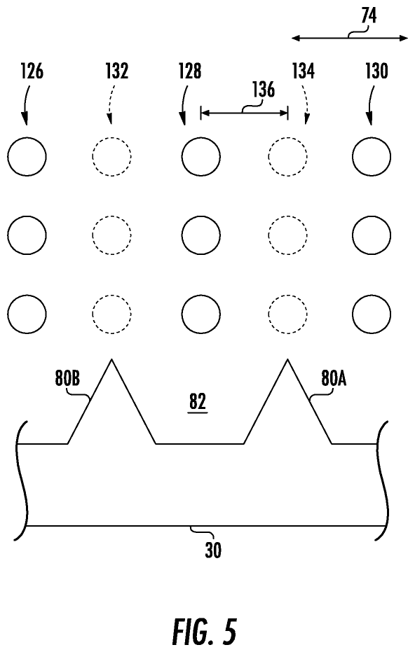

FIG. 5 illustrates an example top view of a portion of the header 30 of the vehicle 10 positioned relative to a plurality of crop rows within the field. More specifically, the illustrated portion of the field includes crop rows 126, 128, 130, which are currently present within the field (e.g., crop rows that will be harvested by the vehicle 10). Furthermore, FIG. 5 also illustrated the locations of crop rows 132, 134 depicted in a previously generated field map associated with the illustrated portion of the field (e.g., a field map generated during planting). As shown, the crop rows 126, 128, 130 currently present within the field are offset from the crop rows 130, 132 depicted in the field map by lateral distance 136, such as due to signal drift associated with the location sensor 102. In the example shown in FIG. 5, it may be assumed that a row divider 80A of the header 30 may correspond to the guide component of the vehicle 10. As such, the crop row 128, which is aligned with the stalkway 82 adjacent to the row divider 80A (i.e., the stalkway 82 defined by the row divider 80A and an adjacent row divider 80B), corresponds to the guide crop row. In this respect, upon receipt of an input associated with the vehicle 10 being located at the starting point of the crop row 128 from the operator, the controller 116 may be configured to determine the location of the crop row 128 based on data received from the location sensor 102. Thereafter, the controller 116 may be configured to compare the location of the crop row 128 (i.e., the guide crop row) to the location of a selected crop row depicted in the field map (e.g., the crop row 134, which is closest to actual location of the crop row 128) to determine the initial location differential (e.g., the lateral distance 136) associated with these crop rows 128, 134.

Referring again to FIG. 3, in accordance with aspects of the present subject matter, the controller 116 may be configured to adjust the field map based on the determined initial location differential. As described above, the controller 116 may be configured to determine the initial location differential between the guide crop row currently present within the field and the selected crop row depicted in the field map. Such differential may, in turn, be indicative of how the locations of the crop row present within the field differ the locations of the crop rows depicted in the field map. In this respect, the controller 116 may be configured to adjust the field map such that the selected crop row depicted in the field map is aligned (e.g., in the lateral direction 74) with the guide crop row. For example, in several embodiments, the controller 116 may be configured to shift the frame reference of the field map in the lateral direction 76 such that the selected crop row in depicted in the field map is aligned the lateral direction 74 with the guide crop row. However, in alternative embodiments, the controller 116 may be configured to adjust the field map based on the determined initial location differential in any other suitable manner.

Thereafter, the controller 116 may be configured to control the direction of travel of the vehicle 10 as the vehicle 10 travels across the field based on the adjusted field map. More specifically, after adjusting the field map, the operator may proceed with the operation (e.g., the harvesting operation) to be performed on the field. In this respect, as the vehicle 10 travels across the field, the controller 116 may be configured to control the direction of the travel 12 of vehicle 10 based on the adjusted field map. For example, the controller 116 may be configured to transmit control signals to the steering actuator 36 (e.g., via the communicative link 122). The control signals may, in turn, instruct the steering actuator 36 to adjust the direction of travel 12 of the vehicle 10 such that the guide component (e.g., one of the row dividers 80 of header 30) of vehicle 10 is maintained in predetermined positional relationship with the guide crop row.

In several embodiments, as the vehicle 10 travels across the field, the controller 116 may be configured to control the direction of travel 12 based on data received from the crop row sensor 104 in addition to the adjusted field map. As described above, the vehicle 10 may include a crop row sensor 104 configured to capture data indicative of the location of the guide crop row. In this respect, as the vehicle 10 travels across the field relative to the guide crop row, the controller 116 may be configured to receive data from the crop row sensor (e.g., via the communicative link 122). The controller 116 may then be configured to analyze or process the received data to determine the location of the guide crop row within the field. As such, the controller 116 may be able to monitor the location of the guide crop row as the vehicle 10 travels across the field.

Additionally, the controller 116 may be configured to compare the monitored location of the guide crop row and the location of the selected crop row depicted in a field map. In certain instances, as the vehicle 10 travels across the field, the crop rows present within the field may curve. As such, the signal drift experienced by the location sensor 102 may cause the positions of the curved portions of the crop rows present within the field (e.g., at the time of harvest) to differ from the positions of the curved portions of the crop rows depicted in the adjusted field map (e.g., generated during planting). Specifically, such signal drift may cause the frame of reference of the location data currently being captured (e.g., to determine the location of the guide crop row) to differ from the frame of reference adjusted field map. As such, in certain instances, the determined position of a curved portion of the guide crop row may be angularly offset from the corresponding curved portion of the selected crop row depicted in the field map. In this respect, the controller 116 may be configured to compare to monitored location of the guide crop row (e.g., as determined by the crop row sensor 104) and the location of the selected crop row depicted in the adjusted field map to determine an operational location differential. As will be described below, the controller 116 may be configured to use the determined operational location differential to further adjust the adjusted field map such that the selected crop row is aligned with the guide crop row.

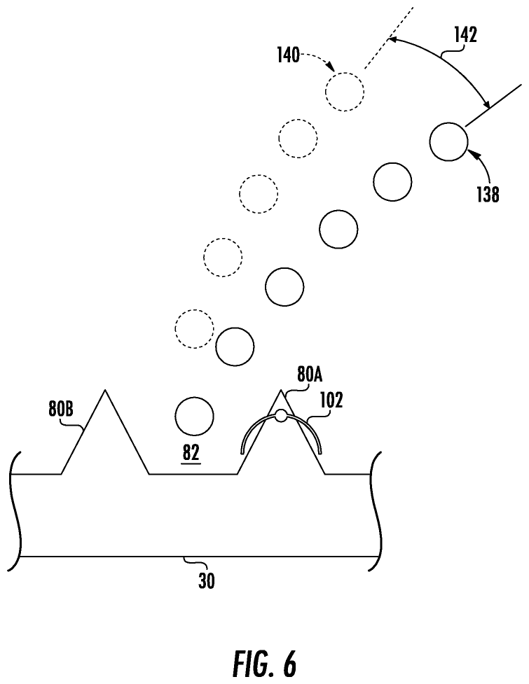

FIG. 6 illustrates an example top view of a portion of the header 30 of the vehicle 10 being positioned relative to a guide crop row 138 within the field as the vehicle 10 travels across the field. More specifically, as shown, the guide crop row 138 curves in the illustrated portion of the field. Furthermore, a corresponding curved portion of a selected crop row 140 depicted in a previously generated field map is shown in the illustrated portion of the field. Moreover, as shown, the guide crop row 138 currently present within the field is offset from the selected crop row 140 depicted in the field map by an angle 142, such as due to signal drift associated with the location sensor 102. In this respect, the controller 116 may be configured to monitor the location of the guide crop row 138 based on data received from the crop row sensor 104. Thereafter, the controller 116 may be configured to compare the location of the guide crop row 138 to the location of the selected crop row 140 depicted in the field map to determine the operation location differential (e.g., the angle 142) associated with these crop rows 138, 140.

Referring again to FIG. 3, the controller 116 may be configured to further adjust the adjusted field map based on the determined operational location differential. As described above, the controller 116 may be configured to determine the operational location differential between the guide crop row currently present within the field and the selected crop row depicted in the field map as the vehicle 10 travels across the field. Such differential may, in turn, be indicative of how the locations of the crop rows present within the field differ the locations of the crop rows depicted in the field map. In this respect, the controller 116 may be configured to further adjust the adjusted field map such that the selected crop row is aligned (e.g., angularly aligned) with the guide crop row. For example, in several embodiments, the controller 116 may be configured to rotate the frame of reference of the field map such that the selected crop row in depicted in the field map is angularly aligned with the guide crop row. However, in alternative embodiments, the controller 116 may be configured to further adjust the adjusted field map based on the determined operational location differential in any other suitable manner.

Furthermore, in one embodiment, the controller 116 may be configured to determine when the accessed field map does not depict the field across which the vehicle 10 is traveling. As described above, the controller 116 may be configured to access one of a plurality of field maps stored within its memory 120 based on a received operator input. However, in certain instances, the operator input received by the controller 116 may be indicative of the incorrect field map. In such instances, features depicted in the accessed field map may not be present in the field across which the vehicle 10 is traveling. For example, the data received from the crop row sensor 104 may indicate that portions of the guide crops row currently present within the field are curved. However, none of the crop rows depicted in the accessed field map may have curved portions. As such, in several embodiments, the controller 116 may compare the guide row present within the field to selected crop row depicted in the accessed field map as the vehicle 10 travels across the field to perform the agricultural operation. When a feature of the guide crop row (e.g., a curve) is not present in the selected crop row (e.g., the selected crop row is completely straight), the controller 116 may be configured to notify the operator (e.g., via the user interface 124) that the incorrect field map has been accessed. Thereafter, the operator may provide an input (e.g., via the user interface 124) indicative of the correct field across which the vehicle 10 is traveling, thereby allowing the controller 116 to access the correct field map from is memory 120.

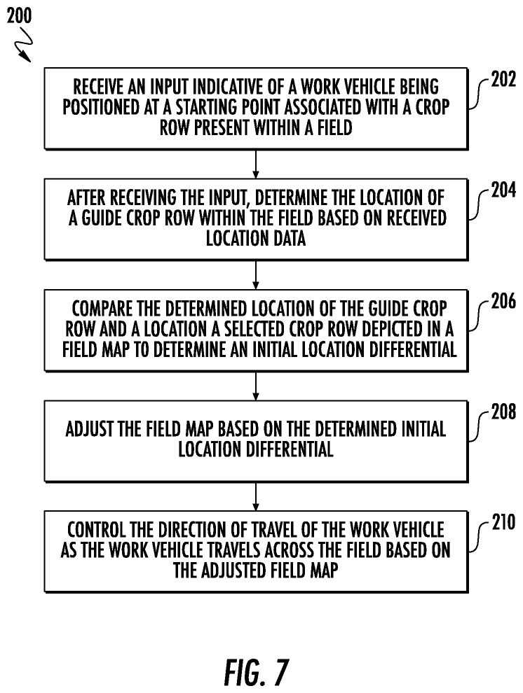

Referring now to FIG. 7, a flow diagram of one embodiment of a method 200 for controlling the direction of travel of a work vehicle is illustrated in accordance with aspects of the present subject matter. In general, the method 200 will be described herein with reference to the work vehicle 10 and the system 100 described above with reference to FIGS. 1-6. However, it should be appreciated by those of ordinary skill in the art that the disclosed method 200 may generally be implemented with any work vehicles having any suitable vehicle configuration and/or within any system having any suitable system configuration. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 7, at (202), the method 200 may include receiving, with one or more computing devices, an input indicative of a work vehicle being positioned at a starting point associated with a guide crop row present within a field. For instance, as described above, the controller 116 may be configured to receive an input from the operator (e.g., via the user interface 124) indicative of the vehicle 10 being positioned at a starting point associated with a guide crop row present within a field.

Additionally, at (204), after receiving the input, the method 200 may include, determining, with the one or more computing devices, the location of the guide crop row within the field based on received location data. For instance, as described above, the controller 116 may be configured to determine the location of the guide crop row within the field based on received location data.

Moreover, as shown in FIG. 7, at (206), the method 200 may include comparing, with the one or more computing devices, the determined location of the guide crop row and a location of a selected crop row depicted in a field map to determine an initial location differential. For instance, as described above, the controller 116 may be configured to compare determined location of the guide crop row and a location of a selected crop row depicted in a field map to determine an initial location differential.

Furthermore, at (208), the method 200 may include adjusting, with the one or more computing devices, the field map based on the determined initial location differential. For instance, as described above, the controller 116 may be configured to adjust the field map based on the determined initial location differential.

In addition, as shown in FIG. 7, at (210), the method 200 may include controlling, with the one or more computing devices, the direction of travel of the work vehicle as the work vehicle travels across the field based on the adjusted field map. For instance, as described above, the controller 116 may be configured to control the operation of a steering actuator 36 of the vehicle 10 to control the direction of travel 12 of the vehicle 10 as the vehicle 10 travels across the field based on the adjusted field map.

It is to be understood that the steps of the method 200 are performed by the controller 116 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 116 described herein, such as the method 200, is implemented in software code or instructions which are tangibly stored on a tangible computer readable medium. The controller 116 loads the software code or instructions via a direct interface with the computer readable medium or via a wired and/or wireless network. Upon loading and executing such software code or instructions by the controller 116, the controller 116 may perform any of the functionality of the controller 116 described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for controlling a direction of travel of a work vehicle, the system comprising:
a location sensor configured to capture data indicative of a location of the work vehicle within a field; and
a controller communicatively coupled to the location sensor, the controller configured to:
receive an input indicative of the work vehicle being positioned at a starting point associated with a guide crop row present within the field;
after receiving the input, determine the location of the guide crop row within the field based on the data captured by the location sensor;
compare the determined location of the guide crop row and a location of a selected crop row depicted in a field map to determine an initial location differential; and
adjust the field map based on the determined initial location differential.

2. The system of claim 1, wherein the controller is further configured to control the direction of travel of the work vehicle as the work vehicle travels across the field based on the adjusted field map.

3. The system of claim 1, wherein, when adjusting the field map, the controller is further configured to laterally shift the field map relative to the determined location of the work vehicle such that the selected crop row depicted in the field map is aligned with the determined location of the initial crop row.

4. The system of claim 1, wherein the selected crop row corresponds to a crop row depicted in the field map that is closest to the determined location of the initial crop row.

5. The system of claim 1, further comprising:
a crop row sensor configured to capture data indicative of a location of the guide crop row present within the field as the work vehicle travels across the field, the controller further configured to:
monitor the location of the guide crop row relative to the work vehicle based on the data captured by the crop row sensor;
compare the monitored location of the guide crop row and the location of the selected crop row depicted in the adjusted field map to determine an operational location differential; and
further adjust the adjusted field map based on the determined operational location differential.

6. The system of claim 5, wherein, when further adjusting the field map, the controller is further configured to rotate the field map such that the selected crop row depicted in the field map is aligned with the monitored location of the guide crop row.

7. The system of claim 5, wherein controller is further configured to access a field map from a plurality of field maps based on a received operator input.

8. The system of claim 7, wherein the controller is further configured to:
determine when the accessed field map does not depict the field; and
provide a notification to an operator of the work vehicle indicating that the accessed field map does not depict the field.

9. The system of claim 5, wherein the crop row sensor is configured as a mechanical sensor.

10. The system of claim 1, wherein the field map is generated during a previous agricultural operation.

11. The system of claim 1, wherein the work vehicle is configured as a harvester.

12. A method for controlling a direction of travel of a work vehicle, the method comprising:
receiving, with one or more computing devices, an input indicative of the work vehicle being positioned at a starting point associated with a guide crop row present within a field;
after receiving the input, determining, with the one or more computing devices, a location of the guide crop row within the field based on received location data;
comparing, with the one or more computing devices, the determined location of the guide crop row and a location of a selected crop row depicted in a field map to determine an initial location differential;
adjusting, with the one or more computing devices, the field map based on the determined initial location differential; and
controlling, with the one or more computing devices, the direction of travel of the work vehicle as the work vehicle travels across the field based on the adjusted field map.

13. The method of claim 12, wherein adjusting the field map comprises laterally shifting, with the one or more computing devices, the field map relative to the determined location of the guide crop row such that the selected crop row depicted in the field map is aligned with the determined location of the guide crop row.

14. The method of claim 12, wherein the selected crop row corresponds to a crop row depicted in the field map that is closest to the determined location of the guide crop row.

15. The method of claim 12, further comprising:
monitoring, with the one or more computing devices, the location of the guide crop row relative to the work vehicle based on the received crop row sensor data;
comparing, with the one or more computing devices, the monitored location of the guide crop row and the location of the selected crop row depicted in the adjusted field map to determine an operational location differential; and
further adjusting, with the one or more computing devices, the adjusted field map based on the determined operational location differential.

16. The method of claim 15, wherein further adjusting the field map comprises rotating, with the one or more computing devices, the field map such that the selected crop row depicted in the field map is aligned with the monitored location of the guide crop row.

17. The method of claim 15, further comprising:
accessing, with the one or more computing devices, a field map from a plurality of field maps based on a received operator input.

18. The method of claim 17, further comprising:
determining, with the one or more computing devices, when the accessed field map does not depict the field; and
providing, with the one or more computing devices, a notification to an operator of the work vehicle indicating that the accessed field map is does not depict the field.

19. The method of claim 12, wherein the field map is generated during a previous agricultural operation.

20. The method of claim 12, wherein the work vehicle is configured to perform a harvesting operation.
